(19) United States
(12) Patent Application Publication
(10) Pub. No.: US 2010/0268904 A1
(43) Pub. Date: Oct. 21, 2010

(54) APPARATUS AND METHODS FOR REGION LOCK MANAGEMENT ASSIST CIRCUIT IN A STORAGE SYSTEM

(76) Inventors: Robert L. Sheffield, Longmont, CO (US); Gerald E. Smith, Longmont, CO (US); Timothy E. Hoglund, Colorado Springs, CO (US); Adam Weiner, Henderson, NV (US)

Correspondence Address: Duft Bornsen & Fishman LLP, 1526 Spruce Street, Suite 302, Boulder County, CO, 80302, US

(21) Appl. No.: 12/760,434

(22) Filed: Apr. 14, 2010

Related U.S. Application Data
(60) Provisional application No. 61/169,407, filed on Apr. 15, 2009.

(51) Int. Cl. G06F 12/14

(52) U.S. Cl. 711/163; 711/E12.091

(57) ABSTRACT

Apparatus and methods for improved region lock management in a storage controller. A region lock management circuit coupled with a memory is provided for integration in a storage controller. One or more I/O processor circuits of the storage controller transmit requests to the region lock management circuit to request a temporary lock for a region of storage on a volume of the storage system. The region lock management circuit determines whether the requested lock may be granted or whether it conflicts with other presently locked regions. Presently locked regions and regions to be locked are represented by region lock data structures. In one exemplary embodiment, the region lock data structures for each logical volume may be stored as a tree data structure. A tree assist circuit may also be provided to aid the region lock management circuit in managing the region lock tree data structures.

### RELATED PATENTS

This patent is related to commonly owned U.S. patent application Ser. No. 09-0266 entitled APPARATUS AND METHODS FOR TREE MANAGEMENT ASSIST CIRCUIT IN A STORAGE SYSTEM, which is hereby incorporated by reference (hereinafter referred to as the “Sibling” patent).

This patent application claims priority to U.S. provisional patent application Ser. No. 61/169,407, filed 15 Apr. 2009, which is hereby incorporated by reference.

### BACKGROUND

1. Field of the Invention

The invention relates generally to storage systems and more specifically relates to a region lock management circuit to manage temporary locks of regions of storage in a storage system.

2. Discussion of Related Art

Storage systems or devices typically include a storage controller allowing a host system to couple to the storage system/device. The storage device/system receives I/O requests through the controller from attached host systems. I/O requests received by the storage controller may be encoded, for example, as SCSI (Small Computer Systems Interface) commands. Processing of the I/O requests in the storage controller may involve a number of computations and significant data processing. For example, processing of I/O requests may include management of temporary locks on regions/portions of data stored in logical volumes of the storage system. Region locks may be utilized where multiple processes are accessing a storage volume (e.g., multiple processes operating on one or more attached host systems generating I/O requests for processing in the storage controller). In such cases, it may be required to apply a temporary lock (either exclusive or non-exclusive) on a region of stored data to allow one I/O request to access the data while other requests are held off by the temporary lock.

Processing of region locks in a storage controller may entail significant processing by a general-purpose processor of the storage controller. Further, some storage controllers may include customized circuits for faster processing of I/O requests (i.e., a “fast-path” I/O processor to improve performance of common read and write I/O request processing). Region locks utilized in processing of I/O requests present further problems for such “fast-path” I/O request processing in that the fast-path processing circuits may rely on the general-purpose processor to provide the required region lock processing even for the fast-path I/O request processing circuits. Such reliance on software/firmware operable in a general-purpose processor of the storage controller to process region lock requests substantially degrades overall performance of the storage system. Such overhead processing is a more acute problem as storage systems incorporate solid-state storage devices (e.g., RAM “disks” or flash memory “disks”). Such solid state memory devices used as “disk” storage devices have significantly lower latency delays in processing of requests and thus overhead processing of the storage controller (such as for region lock processing) represents a higher percentage of the processing to complete an I/O request.

Thus, it is an ongoing challenge to provide efficient processing of region locks in a storage controller.

### SUMMARY

The present invention solves the above and other problems, thereby advancing the state of the useful arts, by providing circuits and methods for fast processing of region lock requests. Apparatus in a storage controller includes a region lock management circuit adapted to receive region lock management requests from I/O processors of the storage controller.

A first aspect hereof provides apparatus in a storage controller of a storage system for managing temporary locking of regions of stored data in the storage system. The storage controller having one or more I/O processor circuits. The apparatus comprising a memory adapted to store a plurality of region lock data structures each region lock data structure adapted to identify a region of a logical volume of the storage system that is presently locked or is requested to be locked. The apparatus further comprises a region lock management circuit coupled with the memory and adapted to couple with the one or more I/O processor circuits. The region lock management circuit further adapted to access an identified region lock data structure responsive to a region lock management request received from an I/O processor circuit.

Another aspect hereof provides a storage controller comprising a front-end interface adapted for coupling the storage controller to a host system and a back-end interface adapted to couple the storage controller to a plurality of storage devices. The controller further comprises an I/O processor circuit coupled with the back-end interface and coupled with the front-end interface. The I/O processor circuit adapted to receive a host system I/O request through the front-end interface and adapted to process a received I/O request by accessing storage devices through the back-end interface. The controller also comprises a memory coupled with the general-purpose processor and coupled with the I/O processor circuit. The memory adapted to store a plurality of region lock data structures, each region lock data structure adapted to identify a region of a logical volume of the storage system that is presently locked or is requested to be locked. The controller further comprises a region lock management circuit coupled with the memory and coupled with the I/O processor circuit. The region lock management circuit further adapted to access an identified region lock data structure responsive to a region lock management request received from the I/O processor circuit.

Yet another aspect hereof provides a method operable in a storage controller, the storage controller comprising an I/O processor circuit and a region lock management circuit and a memory. The method comprising receiving an I/O request from an attached host system and transmitting a region lock management request from the I/O processor circuit to the region lock management circuit. The method also comprises receiving in the region lock management circuit a region lock management request from the I/O processor circuit. The request for access to an identified region lock data structure stored in the memory. The method also comprises accessing, by operation of the region lock management circuit, the identified region lock data structure.

### BRIEF DESCRIPTION OF THE DRAWINGS

FIG. 1 is a block diagram of an exemplary storage controller enhanced with a region lock assist circuit in accordance with features and aspects hereof to provide improved management of region locks in the processing of I/O requests.

FIG. 2 is a block diagram providing exemplary additional details of the structure of the region lock management circuit of FIG. 1.

FIGS. 3 through 5 are flowcharts describing exemplary methods to improve processing of region lock requests by use of a region lock management circuit in a storage controller in accordance with features and aspects hereof.

### DETAILED DESCRIPTION OF THE DRAWINGS

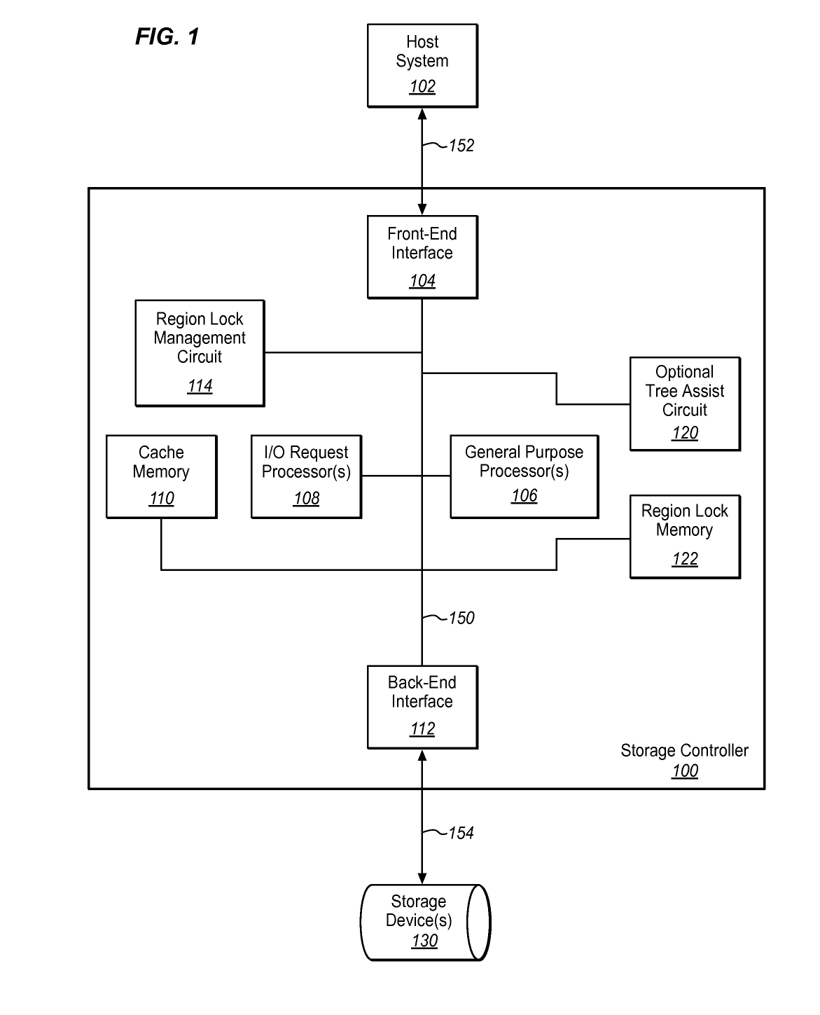

FIG. 1 is a block diagram of a storage controller 100 enhanced in accordance with features and aspects hereof to provide apparatus and methods for high-speed region lock management in processing of an I/O request. Storage controller 100 includes general-purpose processor 106 suitably programmed for controlling overall operation of storage controller 100. Processor 106 may include any memory (not shown) required and suitable for storing data and programmed instructions for the overall operation of the controller 100. In general, general-purpose processor 106 may receive an I/O request from host system 102 through front-end interface 104 via path 152. Front-end interface 104 provides circuitry for coupling storage controller 100 to one or more host systems 102. Front-end interface 104 and communication path 152 coupling the storage controller 100 to host systems 102 may comprise any of several well-known communication media and protocols including, for example, parallel SCSI, Serial Attached SCSI (SAS), Serial Advanced Technology Attachment (SATA), Fibre Channel, Universal Serial Bus (USB), Ethernet, etc. In processing a received I/O request, general-purpose processor 106 communicates through back-end interface 112 to access storage devices 130 via path 154. Back-end interface 112 provides circuitry for coupling storage controller 100 to one or more storage devices 130 via path 154. Back-end interface 112 and communication path 154 may comprise any of several well-known communication media and protocols including, for example, parallel SCSI, SAS, SATA, Fibre Channel, USB, etc. General-purpose processor 106 therefore processes a received I/O request to store data on storage devices 130 (e.g., an I/O write request) or to retrieve data from storage devices 130 (e.g., an I/O read request). Storage controller 100 may include cache memory 110 utilized in processing I/O requests as well known to those of ordinary skill in the art. Internal bus 150 couples the various elements within storage controller 100 and may comprise any of several well-known bus structures including, for example, PCI, PCI-X, PCI Express, AMBA AHB, proprietary processor bus structures, etc. Bus 150 is therefore merely intended to indicate the general concept of communicative coupling among the various components of the enhanced storage controller 100. Those of ordinary skill in the art will readily recognize numerous structures for interconnecting the various functional modules as a matter of design choice.

In some embodiments, storage controller 100 may also include one or more I/O request processor circuits 108 comprising custom circuitry adapted for rapid processing of common I/O requests such as read and write requests. An I/O request processor circuit 108 is sometimes referred to as a “fast-path” request processor in that a typical read or write request from an attached host system 102 may be quickly processed by the dedicated I/O request processor circuits 108 with little or no burden on slower general-purpose processor 106.

Storage controller 100 is enhanced in accordance with features and aspects hereof to include region lock management circuit 114 and associated region lock memory 122. Region lock management circuit 114 and region lock memory 122 may also be coupled to components within storage controller 100 via internal bus 150. Region lock management circuit 114 comprises logic circuits adapted to perform region lock management in conjunction with I/O request processing by general-purpose processor 106 and/or by I/O request processing circuits 108. As noted above, region locking is frequently used in processing I/O requests from multiple sources to coordinate temporary exclusive access that may be required in such I/O request processing. Region lock management circuit 114 offloads the burden of region lock management processing from general-purpose processor 106. In general, general-purpose processor 106 and/or each I/O request processor circuit 108 (collectively or individually also referred to as “I/O processors”) interact with region lock management circuit 114 to access region lock data structures stored in region lock memory 122. For example, region lock management circuit 114 may provide an application circuit interface to allow the I/O processors to acquire or release locks for identified regions of identified logical units managed by the controller 100.

A lock may be acquired for an identified region of an identified logical volume by an I/O processor by generating a region lock acquire request and transmitting the request to region lock management circuit 114. Region lock management circuit 114 then performs all processing associated with acquiring the lock (including optionally waiting to acquire the lock if so requested by the I/O processor). Such processing includes locating and analyzing other region locks previously granted or pending to determine if there are any conflicts associated with granting of a new region lock acquisition request. Each granted or pending lock request may be represented by a corresponding region lock data structure stored in region lock memory 122. Region lock management circuit 114 therefore accesses one or more region lock data structures in region lock memory 122 to determine if any previously granted or currently pending region locks would conflict with the new region lock acquire request. If there is no conflict, the lock may be granted and the region lock data structure for the newly granted lock is added to the structures in region lock memory 122. If the lock cannot be granted at present, depending on the parameters of the region lock acquire request, the new lock request may simply be rejected or may be left pending awaiting an opportunity to be granted when all conflicts have been cleared. Such a lock request left pending may also be represented by a corresponding region lock data structure in memory 122.

When a granted region lock is no longer required, an I/O processor may issue a region lock release request to the region lock management circuit 114 (e.g., the I/O processor that acquired the lock or another I/O processor if processing of the underlying request is transferred from one I/O processor to another). The release request identifies the region lock previously granted (e.g., by pointing to the region lock data structure in memory 122). The region lock management circuit 114 then releases the identified, previously granted region lock by removing or otherwise marking the region lock data structure in memory 122 (e.g., by unlinking the structure from a list or tree structure that associates it with a presently active lock). When the previously granted region lock is so released, region lock management circuit 114 analyzes any pending region locks represented by region lock data structures in memory 122 to locate pending locks that previously were in conflict with the just released region lock. Any located, pending region locks that may now be granted are then processed by region lock management circuit 114 to grant the pending requests in response to the newly released region lock.

The region lock data structures may be stored as nodes of a tree data structure. The nodes of such a tree data structure are the region lock data structures (which may include fields appropriate for linking the data structure into a tree data structure). Where the region lock data structures are stored as nodes of a tree data structure in memory 122, region lock management circuit 114 accesses and manipulates the region lock data structures using well-known tree management algorithms. In one exemplary embodiment, storage controller 100 may also include an optional tree assist circuit 120 for improving speed of management of the tree data structures in memory 122. Tree assist circuit may couple with other components in storage controller 100 via bus 150. In particular, region lock management circuit 114 may utilize tree assist circuit 120 to create a tree data structure in memory 122 for each logical volume managed by controller 100. As region locks are requested and granted, region lock data structures may be inserted in the tree data structure for the identified logical volume. When a granted lock is released, the corresponding region lock data structure may be deleted from the tree data structure. The required insertion and deletion of nodes in the tree data structure may be performed by the tree assist circuit 120 through interaction with region lock management circuit 114. The co-pending, commonly owned, Sibling patent provides one exemplary implementation of a tree assist circuit that may be sued in conjunction with region lock management circuit 114.

Those of ordinary skill in the art will readily recognize numerous additional and equivalent components in a fully functional storage controller. Such additional and equivalent components are omitted from FIG. 1 for simplicity and brevity of this discussion. Further, in one exemplary embodiment, the functions of region lock management circuit 114 and the tree assist circuit 120 may be implemented as integral within I/O request processor circuits 108. In such an exemplary embodiment, connectivity among the logic circuits that comprise region lock management circuit 114, I/O request processors 108 and tree assist circuit 120 may be achieved by any suitable signaling paths rather than a more general-purpose bus structure such as suggested by bus 150. Thus, as noted above, connectivity of the functional modules as indicated by bus 150 is merely intended to broadly express the communications that may be present in various embodiments.

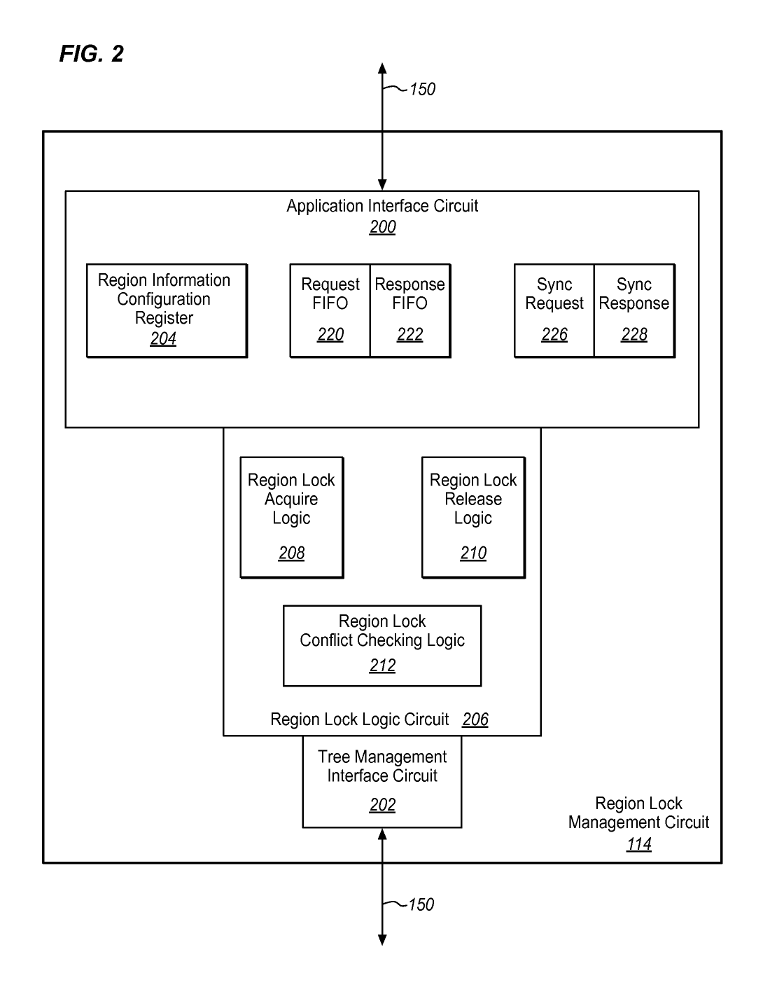

FIG. 2 is a block diagram depicting additional exemplary details of one embodiment of region lock management circuit 114 of FIG. 1. Region lock management circuit 114 may include an application interface circuit 200 comprising region information configuration register 204. One or more region information data structures may also be stored in the region lock memory. Each region information structure identifies a tree data structure in the region lock memory corresponding with an associated logical volume of the storage system. A plurality of such region information structures may be stored in contiguous memory locations such that the tree data structure for an identified logical volume may be located by simply indexing into the contiguously stored region information data structures. The region information configuration register 204 may be programmed (e.g., by the general-purpose processor of the storage controller during initialization) to point to the start of the contiguous memory locations that store the region information data structures.

In addition, application interface circuit 200 may include means for interfacing with application circuits (e.g., I/O processors) to receive and process region lock management requests. Request FIFO 220 and response FIFO 222 collectively comprise an asynchronous interface for application circuits (i.e., I/O processors of the storage controller) to request region lock management functions (e.g., lock acquire and lock release requests). An I/O processor may add a request to request FIFO 220 and continue processing other aspects of a corresponding I/O request. When the region lock management request is completed by region lock management circuit 114, an appropriate response is added to response FIFO 222.

In addition, sync request 226 and sync response 228 comprise a synchronous interface whereby an application circuit may issue a request in the sync request interface 226 and await a corresponding response in the sync response interface 228 before continuing any further processing of an I/O request. A synchronous request and response may be performed, for example, when the I/O processor cannot proceed further with processing of an I/O request until the region lock management request is completed. By contrast, an asynchronous request and response may be appropriate where the I/O processor is capable of proceeding with further processing of an I/O request while awaiting the completion of the region lock management request. Those of ordinary skill in the art will recognize standard arbitration logic that may be associated with the application interface circuit 200 to help avoid conflicts from simultaneous requests. Such arbitration logic is well known to those of ordinary skill in the art and thus omitted for simplicity and brevity of this discussion. Other features and logic of the region lock management circuit 114 help avoid processing of conflicting or incoherent requests from multiple application circuits. In one exemplary embodiment, each I/O processor coupled with the region lock management circuit 114 may be provided with its own dedicated interface to the circuit 114. In such an embodiment, circuit 114 includes suitable logic to select which interface will be serviced next. In other embodiments where a single asynchronous interface circuit 200 is used to couple the circuit 114 to multiple I/O processors, well-known arbitration logic may be employed within circuit 114 or the bus structure coupling the circuit 114 to the multiple I/O processors (through a shared interface 200) may provide any required arbitration as well-known in the art.

Region lock management circuit 114 may also include region lock logic circuit 206 comprising logic circuits to perform region lock management functions in response to requests received through application interface circuit 200. In general, region lock logic circuit 206 may comprise region lock acquire logic circuit 208 providing functionality to acquire a new region lock in response to a received request. Circuit 206 may also comprise region lock release logic circuit 210 to release an identified region lock (typically a previously granted lock request). Further, region lock logic circuit 206 may comprise region lock conflict checking logic circuit 212 to determine whether a particular region lock acquire request conflicts with any other pending or previously granted (i.e., presently locked) region locks. Exemplary detailed operations of the region lock logic circuit 206 are provided herein below.

Where region lock data structures are stored and manipulated as tree data structures, region lock management circuit 114 may also include tree management interface circuit adapted for interfacing with a tree assist circuit as discussed above with regard to FIG. 1. Tree management interface circuit 202 comprises any suitable logic required to interface to a tree assist circuit. Where the tree assist circuit is as described in the Sibling patent application, tree management interface circuit 202 may provide a FIFO/register interface adapted to apply signals to an asynchronous request FIFO of the tree assist circuit and to receive signals from an asynchronous response FIFO of the tree assist circuit providing responses to previously queued requests.

Those of ordinary skill in the art will readily recognize that the decomposition of logic and functions shown in FIG. 2 is intended merely as exemplary of one possible embodiment. Functions and logic of region lock management circuit 114 may be integrated or separated in different manners than that shown in FIG. 2. Further, the entirety of functions and logic of region lock management circuit 114 may be integrated within other circuits of the storage controller 100 of FIG. 1. For example, the entirety of region lock management circuit 114 (and tree assist circuit 120 of FIG. 1) may be integrated with the logic and functions of a “fast-path” I/O request processing circuit (such as circuit 108 of FIG. 1). Further, those of ordinary skill in the art will readily recognize additional and equivalent functional logic blocks and interface circuits that may be present in a fully functional region lock management circuit 114. Such additional and equivalent logic and functions are omitted herein for simplicity and brevity of this discussion.

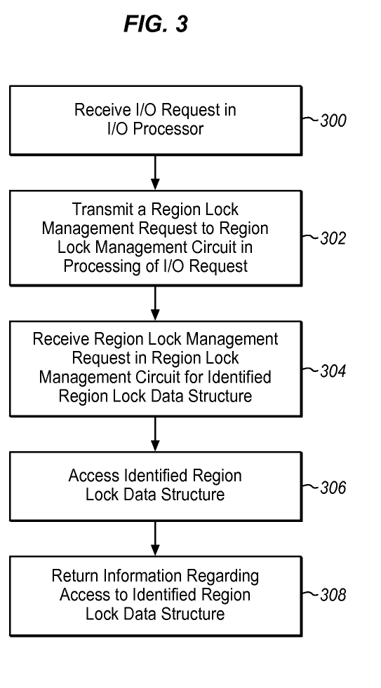

FIG. 3 is a flowchart describing an exemplary method for improved performance in processing region lock management requests in accordance with features and aspects hereof. The method of FIG. 3 may be operable within a storage controller such as controller 100 of FIG. 1 enhanced in accordance with features and aspects hereof to incorporate a region lock management circuit. At step 300, an I/O request is received by an I/O processor of the storage controller from an attached host system. As noted above, an I/O processor may include a general-purpose processor suitably programmed within the storage controller or a customized circuit (“fast-path” I/O request processing circuit) adapted specifically for high-performance I/O request processing. As a portion of processing such a received I/O request, the I/O processor may determine that a region lock may be required to establish and/or release temporary exclusive access to a region of a logical volume associated with the received I/O request. Responsive to such a determination, the I/O processor at step 302 transmits a region lock management request to the region lock management circuit of the storage controller to perform requisite processing to temporarily acquire or release a lock of an identified region affected by processing of the I/O request. As noted above, the transmission of the region lock management request may comprise adding a new entry to a FIFO of queued requests to be processed by the region lock management circuit. In some embodiments, a synchronous request interface may be provided wherein a single request is processed to completion before any further requests to the region lock management circuit are processed. Use of the synchronous versus asynchronous (FIFO queued FIFO) interface is a matter of design choice for implementation within the I/O processors of the storage controller. At step 304, the region lock management circuit receives the transmitted region lock management request. The request includes parameters indicating the identified region of an identified logical volume of the storage system for which the region lock is to be acquired or released. In addition, further parameters may indicate a particular type of region lock to be acquired. For example, a region lock type field in the region lock request may indicate an exclusive lock or any of one or more types of non-exclusive locks. Further details of exemplary types of locks are presented herein below.

Responsive to receipt of the region lock management request, step 306 accesses an identified region lock data structure to acquire or release a region lock or otherwise access information relating to the desired region lock. Step 306 represents all functionality relating to acquisition of a new region lock or release of a previously acquired region lock (as well as other managerial functions that may be requested by an I/O processor coupled with the region lock management circuit). Further details of exemplary processing at step 306 are provided herein below. Step 308 then completes processing of the region lock management request by returning to the I/O processor any appropriate information regarding the requested access to the identified region lock data structure.

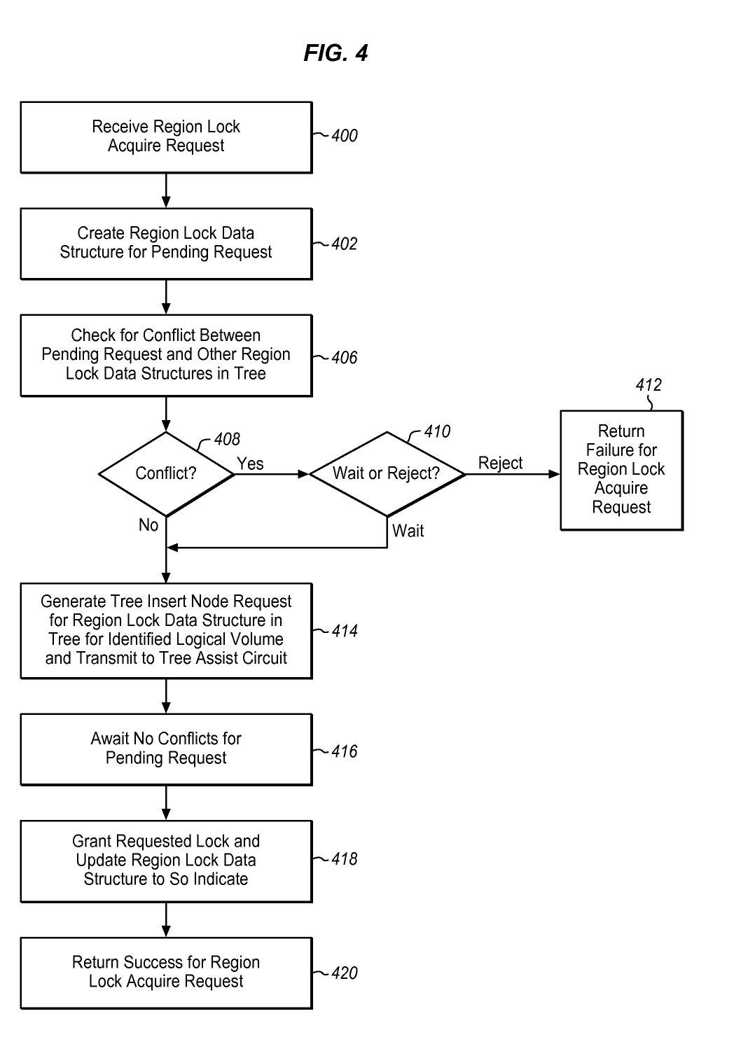

FIG. 4 is a flowchart describing an exemplary method for processing of step 306 of FIG. 3 to acquire a new region lock in accordance with features and aspects hereof. Processing of the method of FIG. 4 may be performed within a region lock management circuit such as circuit 114 of FIGS. 1 and 2. At step 400 and the region lock management circuit first receives a region lock acquire request from an I/O processor coupled with the region lock management circuit. Responsive to receipt of the request, step 402 creates a new region lock data structure representing the pending region lock acquire request. Appropriate parameters may be encoded within the region lock data structure including, for example, a key field indicating the starting logical address of the region to be locked and the length or extent of the region to be locked. Additional fields within the region lock data structure may encode a type of region lock including, for example, an exclusive lock type and one or more non-exclusive lock types.

Using the newly created region lock data structure, step 406 checks for conflicts between the new, pending, request region lock data structure and other region lock data structures representing other pending region lock acquire requests and previously granted region lock acquire requests. Details of the processing to check for conflicts are presented further herein below. In general, the conflict may arise where a previously granted or pending region lock request overlaps the storage identified by the newly generated region lock acquire request. Based on the key values representing the starting address and extent of a defined region, a comparison may be made to determine whether the newly requested region lock overlaps any other previously granted region lock or currently pending region lock acquire request. In addition, the type of region lock may be analyzed to determine whether the overlap gives rise to an actual conflict based on the type of region lock that overlaps the newly generated region lock request. Step 408 then determines whether the analysis of step 406 detected any such conflict. If so, step 410 determines whether the requested region lock acquire request indicates that an immediate return or rejection should be provided if the region lock cannot be immediately granted or whether the requester desires to wait for the requested lock to be granted. If the new region lock acquire acquisition request indicates that an immediate failure should be returned, step 412 returns such an immediate failure signal to the requesting I/O processor for the newly received region lock acquire request. The newly created region lock data structure (by processing of step 402) may be freed at step 412 for reuse in the region lock memory.

If step 410 determines that the I/O processor requesting the region lock wishes to wait for the lock to be granted or if step 408 detected no conflicts, step 414 generates a tree insert node request to insert the created region lock data structure in the tree associated with the identified logical volume. The generated tree insert node request is transmitted to the tree assist circuit associated with the region lock management circuit in the enhanced storage controller. It will be understood by those of ordinary skill in the art that the tree assist circuit logic may be integral with the region lock management circuit or may be implemented as a separate circuit in the enhanced storage controller as a matter of design choice. In one exemplary embodiment, the tree assist circuit is implemented as a separate circuit from the region lock logic to simplify other logic within a storage controller utilizing the features of the tree assist circuit for other I/O processing capabilities.

Step 416 then awaits a determination that all conflicts with the new generated region lock data structure are eliminated (i.e., by release of previously granted region locks or based on analysis of the types and sequence of other pending region lock requests as discussed in further detail below). If steps 406 and 408 already determined there are no conflicts, step 416 completes essentially immediately (i.e., is a “no-op”). Following insertion of the region lock data structure in the tree data structure for the identified logical volume and clearing of any conflicts, step 418 grants the requested lock and updates the region lock data structure to so indicate that the requested region lock has been granted. Step 420 then returns a successful status indication to the requesting I/O processor to indicate that the requested region lock has been granted.

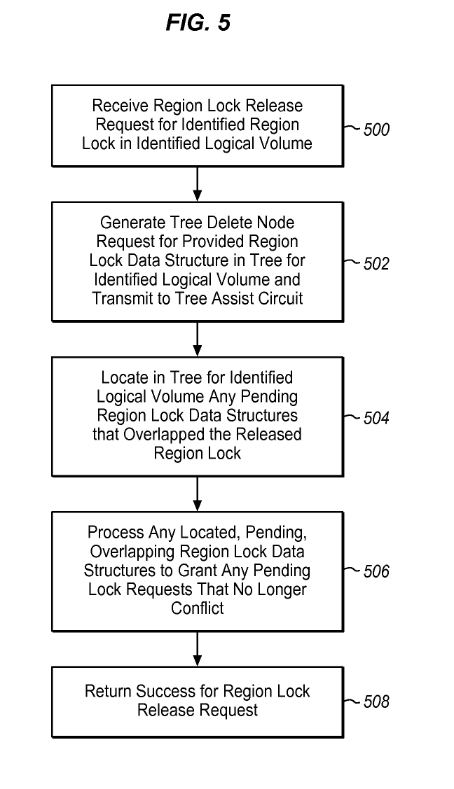

FIG. 5 is a flowchart describing another exemplary method for processing of step 306 of FIG. 3 to release a previously granted region lock in accordance with features and aspects hereof. Processing of the method of FIG. 4 may be performed within a region lock management circuit such as circuit 114 of FIGS. 1 and 2. At step 500, the region lock management circuit receives a region lock management release request to relinquish a previously granted region lock for an identified portion of an identified logical volume. Parameters of the provided region lock data structure from the I/O processor identify the region and the logical volume to be released. At step 502, the region lock management circuit generates a tree delete node request and transmits the generated tree delete node request to the tree assist circuit of a storage controller. The tree delete node request identifies the region lock data structure and the tree data structure associated with the identified logical volume and requests that the tree assist circuit delete the region lock data structure from the identified tree data structure. The released region lock data structure is then available for re-use in the memory storing the region lock data structures. At step 504, the region lock management circuit, again utilizing functions of the tree assist circuit, locates other region lock data structures (nodes) in the tree data structure corresponding to the identified logical volume that may have overlapped the released region lock. Any such located overlapping region lock data structures may represent either previously granted lock requests (i.e., other non-exclusive region locks) or may represent pending region lock requests that conflicted with the just released region lock. At step 506, the region lock management circuit processes any such pending region lock requests that overlapped the just released region lock. In one exemplary embodiment, the region lock management circuit updates any such located pending lock entries in the tree data structure that overlapped the region whose lock was just released. The pending lock request entries so located are updated to reflect that they have been granted. In addition, an appropriate response may be added to the queue of responses in the interface to the I/O processors (e.g., added to the response FIFO) to indicate that the previously pending lock request has been granted. I/O processors coupled to the region lock management circuit will eventually retrieve the queued response (e.g., by polling or based on a generated interrupt signal) and resume processing the underlying I/O request appropriately. Step 508 then returns a successful completion signal for the region lock release request to the I/O processor that generated release request (or such other processor as may now be responsible for processing of the region lock).

Those of ordinary skill in the art will readily recognize equivalent and additional steps that may be utilized in the methods of FIGS. 3 through 5. Such additional and equivalent steps are omitted herein for simplicity and brevity of this discussion.

As noted above, a region lock data structure may include a field indicating a type of the associated region lock. Types of region locks may include EXCLUSIVE region locks and one or more other non-EXCLUSIVE region lock types. In one exemplary embodiment, only one type of region lock is EXCLUSIVE; any other type is non-EXCLUSIVE. A non-EXCLUSIVE (or shared) region lock blocks, and is blocked by, any overlapping non-EXCLUSIVE region locks of a different type, and by any overlapping EXCLUSIVE region locks. A non-EXCLUSIVE region lock does not block, and is not blocked by, other non-EXCLUSIVE region locks of the same type. An EXCLUSIVE region lock blocks all overlapping region lock requests of all types.

In one exemplary embodiment, the tree assist circuit is adapted to manage AVL trees. Thus, the region lock data structures are managed by the region lock management circuit in conjunction with a tree assist circuit as AVL tree data structures. The key field of the region lock data structures in the AVL tree data structures is the starting logical block address of the region locked by the corresponding region lock data structure. The Sibling patent describes details of such a tree assist circuit that may be utilized in a storage controller enhanced in accordance with features and aspects hereof. Further details of an exemplary embodiment of a region lock management circuit and its operation are presented herein below presuming such a tree assist circuit is used to manage AVL tree data structures in the region lock memory.

Region locking may be managed independently for each logical volume of the storage system (e.g., RAID logical volumes, snapshot copies, and other logical volumes up to a designed maximum such as 1024 volumes). Each logical volume is associated with a REGION_INFO that structure that contains the TreeIndex of an AVL tree assigned to the logical volume. The REGION_INFO structure may also include an incrementing 32-bit sequence number used to mark each REGION LOCK node linked into the AVL tree (used to determine relative age of REGION LOCK entries). The following table describes an exemplary REGION_INFO data structure.

| | Length | |
|---|---|---|
| Field | (bytes) | Description |
| TreeIndex | 2 | The index of the AVL tree assigned to manage |
| | | region locks for a given logical volume. It |
| | | is an index to an array of contiguous |
| | | TREE_INFO structures initialized storage |
| | | controller firmware. |
| reserved | 2 | Pad for alignment |
| seqNum | 4 | The sequence number for the next REGION_LOCK |
| | | entry added to the AVL tree. |
| Pad | 24 | Pad to 32-byte boundary (may be used for |
| | | additional firmware-specific information) |

Storage controller initialization firmware writes the base address of an array of REGION_INFO structures into the RegionLockConfiguration register (204 of FIG. 2). The table below describes the format of an exemplary region lock configuration register 204.

| | Length | |
|---|---|---|
| Field | (bytes) | Description |
| RegInfoBase | 4 | Base address of an array of REGION_INFO |
| | | structures |

The region lock data structures (REGION_LOCK) include an AVL tree structure to permit linking and manipulation within an AVL tree data structure and includes a number of other fields used to processing of region lock management requests. The following table describes an exemplary REGION_LOCK data structure as stored in the region lock memory.

| | | | Overlapping | | |
|---|---|---|---|---|---|
| | Length | | REGION_HEADER structure | | |
| Field | (bytes) | Description | Bytes | Name | |
| Node | 32 | A TREE_NODE | 0-3 | Low | Start address |
| | | structure to link elements | 4-6 | High | (first LBA)¹ |

| | | |
|---|---|---|
| into an AVL tree | 7 | Pad-1 |

| | | |
|---|---|---|
| 8-11 | Low | Max: 56-bit |
| 12-14 | High | integer = end- |
| | | point of sub- |
| | | tree's region |

| | |
|---|---|
| 15 | Balance |
| 16 to 27 | Tree node linking |
| | elements |
| 28 to 31 | Len - number of blocks |
| | in region |

| Type | 1 | Region type {0 = None, 1 = SHARED_READ, 2 = | |
|---|---|---|---|
| | | SHARED_WRITE, 3 = EXCLUSIVE, 4 = | |
| | | SHARED_UNSPECIFIED}. Other values (i.e., non- | |
| | | EXCLUSIVE) are accepted as well (block all non-matching | |
| | | types). | |
| Granted | 1 | 0x00 = not yet granted, 0x01 (or non-zero) = granted | |
| Request | 1 | I/O processor issues a request by storing a non-zero value in | |
| | | the Request field and then storing a pointer to the | |
| | | REGION_LOCK structure in the Region Lock request FIFO. | |
| Destination | 1 | {0x00-0x07 = CPU, 0x08 = Fast-Path I/O Processor} I/O | |
| | | processor requesting the region lock - and thus the I/O | |
| | | processor to be notified of success/failure of a region lock | |
| | | management request | |
| seqNum | 4 | Sequence number for this request. Used to prioritize older | |
| | | requests. | |
| RI-Index | 2 | Index to a REGION_INFO structure identifying the tree this | |
| | | region lock management request pertains to. | |
| Pad-2 | 1 | Pad to align | |
| IOP | 1 | Flags useful to Fast-Path I/O processor for managing region | |
| LDFlags | | lock requests | |
| Callback | 4 | Pointer to a call-back function for | These fields are used to |
| | | lock acquisition | interact with a general- |
| Arg | 4 | Integer argument passed to | purpose processor as the |
| | | callback function (e.g., context | I/O processor to invoke a |
| | | pointer) | notification function on |
| | | | success/failure of a region |
| | | | lock management request² |

| | | |
|---|---|---|
| Pad-3 | 16 | Pad to align |

¹The Start field overlaps bytes 0-6 of the TREE_NODE, and is used as the look-up key. AVL trees used for region locks access a common pool of tree nodes, separate from tree nodes used in other AVL trees, allowing tree nodes for region locking to be embedded in REGION LOCK structures.
²The fast-path I/O processor submits region lock requests, but relies on direct reply signals from the region lock management circuit rather than a callback. These fields may be used for other purposes (e.g., flags) when the region lock request originate from the fast-path I/O processor).

Storage controller initialization firmware initializes all of the REGION_INFO and REGION_LOCK data structures stored in the region lock memory.

A region lock management request (e.g., to acquire or release a region lock) is made by writing a pointer to a REGION_LOCK structure to the Region Lock request FIFO. The Start, RL_Destination, Len, Type, Request, and RI-Index fields must be valid when invoking the RegionLockGet, RegionLockRelease, RegionLockTypeSet, and RegionLockTest functions (as described further herein below). Start is a 56-bit field used as the search key by the region lock management circuit to locate entries in the AVL tree used to manage the specified region lock. The value is normally the Row LBA provided by the I/O request, or provided by firmware of the general-purpose processor when submitting a region lock request for management functions within the storage system. The RL_Destination field specifies where the region lock management circuit will route the grant status return for the specified region lock request. A value of 0x00 through 0x07 will cause the region lock management circuit to route the grant status to a corresponding general-purpose processor of the storage controller. A value of 0x08 will cause region lock management circuit to route the grant back to the fast-path I/O processor. When the fast-path I/O processor issues a region lock request, it copies the value of the RL_Destination field (bits 7:4) in the RL_Flags field in the I/O request information provided by the host system driver to the RL_Destination field of the REGION_LOCK structure. Firmware processing an I/O request in the general-purpose processor fills in the RL_Destination field in the REGION_LOCK structure directly when submitting a region lock request. Max is calculated as the ending address for the range of addresses to be locked by a region lock acquire request. Max is calculated and set by the region lock management circuit when its associated tree is modified (i.e., by insertion or deletion of a node or by any action that causes rotation of the tree to re-balance the AVL tree). The Max value stored is calculated as:

MAX(Start+Len−1, leftChild.Max, rightChild.Max).

Max is used by region lock management circuit to help minimize time to search the tree for overlapping entries. The search goes to the left child if the trial node start value is less than or equal to the left child Max. Balance is set by the AVL tree assist circuit when the node is inserted in the tree. It is used to detect tree imbalance and reflects the difference in heights between the left and right sub-trees. After balancing, the Balance should always be −1, 0, or 1. Len is set by the requester (I/O processor) and specifies the number of blocks covered by the region lock and is used, as above, by region lock management circuit in detecting overlapping region locks (i.e., in computing Max). The Type is used by the region lock management circuit to qualify the usage of the region lock. The region lock management circuit processes region locks according to the Type specified as follows:
a) If a region lock is requested and there are no overlapping region locks in the specified tree, the lock will be granted, regardless of type.
b) If a region lock of type REGION_TYPE_EXCLUSIVE has been granted but not yet released, any subsequent overlapping region lock requests, regardless of type, will not be granted and will remain pending until the overlapping granted exclusive region lock is released.
c) If a granted region lock is any type other than REGION_TYPE_EXCLUSIVE, any subsequent overlapping region lock of a different type than the granted lock will not be granted and will remain pending until the granted lock is released.
d) If a granted region lock is any type other than REGION_TYPE_EXCLUSIVE, subsequent overlapping region lock requests of the same type will be granted.

The region lock management circuit sets the value of the Granted field as follows for RegionLockTypeSet request (see functions below):
1. The region lock management circuit checks that the specified region lock is already in the AVL tree.
2. The region lock management circuit region sets the value of Granted to zero if the lock is not immediately granted but remains in the AVL tree pending release of a prior conflicting region lock.
3. The region lock management circuit region sets the value of Granted to one if there are no prior conflicting region locks and the lock is immediately granted.
4. The region lock management circuit region also sets the value of Granted to one when a pending region lock is granted due to the release of a conflicting region lock.

The region lock management circuit sets the value of the Granted field as follows for RegionLockTest request (see functions below):
a) The region lock management circuit does not enter the region lock into the AVL tree.
b) The region lock management circuit region sets the value of Granted to zero and issues a response if the specified AVL Tree contains a conflicting overlapping region lock.
c) The region lock management circuit region sets the value of Granted to one and issues a response if there are no conflicting region locks in the specified AVL tree.

The RegionLockTest function (described below) is issued on the synchronous request interface using an inactive REGION_LOCK structure. The response is read from the synchronous reply interface before issuing additional region lock requests or processing any asynchronous responses.

For the RegionLockRelease request (described below), the region lock management circuit sets the Granted field to zero and removes the specified region lock from the AVL tree.

The Request field is an encoded value requesting a RegionLockGet, RegionLockTest, RegionLockRelease, or RegionLockTypeSet operation. The fast-path I/O processor may submit RegionLockGet and RegionLockRelease requests while the general-purpose processor firmware may submit any of the four requests. The operation requested is performed on the REGION_LOCK structure pointed to by the pointer written to the Region Lock Request FIFO.

The SeqNum is written by the region lock management circuit for a RegionLockGet request. The value stored is retrieved from the seqNum field in the specified REGION_INFO structure before linking the region lock into the AVL tree. The region lock management circuit increments the seqNum field in the REGION_INFO structure once for each RegionLockGet request. The SeqNum field is used to determine the oldest request when a region lock release operation requires the region lock management circuit to grant a lock to one of multiple pending conflicting region locks. The oldest pending region loci request is granted first.

The RI-Index specifies an instance of a REGION_INFO structure to be used in the processing of the region lock request. The REGION_INFO structure, in turn, points to an AVL tree to be used. The storage controller general-purpose processor (at initialization) associates different RI-Index values with different logical volumes so that each logical volume has its own REGION_INFO structure and its own AVL tree. Region locks for different logical volumes never create overlaps or hence conflicts.

When the general-purpose processor submits a region lock request to the asynchronous FIFO, it should specify a pointer to a call-back function in the Callback field, and a context reference in the Arg field. A software/firmware interrupt handler (operable in the general-purpose processor) that services the asynchronous reply FIFO will invoke the function in the Callback field passing the argument specified in the Arg field. The Arg field could be a reference to an I/O request related data structure associated with the region lock.

Firmware operable in a general-purpose processor of the storage controller may implement the following functions to support region locking capabilities.

| Name | Parameters | Response | Description |
|---|---|---|---|
| RegionInit | Pointer to a | None | Sets the TreeIndex field of the |
| | REGION | | REGION_INFO structure to the |
| | INFO | | index of the AVL tree associated |
| | structure | | with the region-locking for the |
| | | | assigned LD. Sets the tree root |
| | | | pointer in the TREE_INFO |
| | | | structure to NULL, sets the |
| | | | seqNum in the REGION_INFO |
| | | | structure to zero, and sets the ID |
| | | | of the compare function to be |
| | | | used for AVL Tree Node key |
| | | | comparison as a 56-bit unsigned |
| | | | integer compare returning −1, 0, |
| | | | or +1 (for <, =, or >). |
| | | | Issues a ChangeRegister request |
| | | | to the AVL Tree for this region. |
| RegionLockInit | Pointer to a REGION | None | Initializes the start, len, type, |
| | LOCK and specified | | callback, arg, and elements in the |
| | parameters | | REGION_LOCK structure prior |
| | | | to invoking RegionLockGet. |
| RegionLockCheck | Tree Index | MonTask( ) | Walks a region lock tree and |
| | | on error | verifies correctness. |
| RegionLockDebug | Tree Index | | Dumps region-lock information |
| RegionLockTypeGet | Pointer to a | REGION | Returns |
| | region lock | TYPE per | REGION_TYPE_UNUSED, |
| | | Description | REGION_TYPE_EXCLUSIVE, |
| | | | or any other value (interpreted as |
| | | | non-exclusive for matching type |
| | | | values) reflecting the contents of |
| | | | the type field in the specified |
| | | | REGION_LOCK structure. |
| RegionLockIsGranted | Pointer to a | TRUE or | Checks the granted field of the |
| | region lock | FALSE | specified region lock, and returns |
| | | | true if the region lock has been |
| | | | granted; otherwise the function |
| | | | returns false. |

The region lock management circuit may implement the following functions (implemented as requests queued on the asynchronous FIFO interface or as requests applied to the synchronous interface—responses are provided in like manner through the asynchronous FIFO queue or through the sync reply interface).

| Request Name | Parameters | Response | Description |
|---|---|---|---|
| RegionLockGet | Available | When granted, RL- | Sets the seqNum in the |
| | REGION_LOCK | pointer is posted to | REGION_LOCK to the value |
| | structure with Start, | the RL response | of the seqNum in the |
| | Len, Type, RI- | FIFO with | REGION_INFO structure, |
| | Index, and if | Granted = 1. | and increments the seqNum in |
| | required by | | the REGION_INFO structure. |
| | firmware of the | | Inserts the REGION_LOCK |
| | general-purpose | | in the tree using the first LBA |
| | processor, Callback | | in the range (i.e., Start) as the |
| | and Arg specified. | | look-up key, scans the tree for |
| | | | overlapping regions with |
| | | | conflicting types, and, if there |
| | | | are no conflicting overlaps, |
| | | | marks the region lock as |
| | | | granted and posts a response |
| | | | to the region lock response |
| | | | FIFO. If there is a conflicting |
| | | | overlap, the REGION_LOCK |
| | | | remains in the tree and no |
| | | | response is generated until |
| | | | any prior conflicting lock(s) |
| | | | are released. When the lock is |
| | | | granted the region lock |
| | | | management circuit sets |
| | | | Granted = 1 and posts a |
| | | | pointer to the REGION |
| | | | LOCK in the response FIFO. |
| | | | This function is issued as an |
| | | | asynchronous request. |
| RegionLockGetIfAvailable | Available | When granted, RL- | This is a synchronous request. |
| | REGION_LOCK | pointer is posted to | Sets the seqNum in the |
| | structure with Start, | the RL response | REGION_LOCK to the value |
| | Len, Type, RI- | FIFO with | of the seqNum in the |
| | Index, and if | Granted = 1. | REGION_INFO structure, |
| | required by | | and increments the seqNum in |
| | firmware of the | | the REGION_INFO structure. |
| | general-purpose | | Invokes RegionLockTest. If |
| | processor, Callback | | the lock is granted, the |
| | and Arg specified. | | REGION_LOCK is inserted |
| | | | in the tree using the first LBA |
| | | | in the range (i.e., Start) as the |
| | | | look-up key, an immediate |
| | | | reply is generated on the |
| | | | synchronous reply queue. |
| | | | If there is a conflicting |
| | | | overlap, the REGION_LOCK |
| | | | is not put into the tree and an |
| | | | immediate synchronous |
| | | | response is generated with the |
| | | | Grant field set to zero in the |
| | | | REGION_LOCK structure |
| | | | provided. |
| RegionLockTest | Inactive | Sets the Granted | Invokes regOverlapFirst to |
| | REGION_LOCK | field to 0x01 if | determine if any existing |
| | structure with Start, | there are no | region locks (pending or |
| | Len, Type, and RI- | conflicting region | granted) overlap the specified |
| | Index specified. | locks, otherwise | range of blocks, sets the |
| | | sets Granted to | Granted field according to the |
| | | 0x00. | result, and posts the address |
| | | | of the REGION_LOCK |
| | | | structure to the synchronous |
| | | | reply queue. The |
| | | | REGION_LOCK structure is |
| | | | used only to provide the range |
| | | | of blocks to test in the |
| | | | specified RL Tree, and a place |
| | | | to log the result. This request |
| | | | is issued on the synchronous |
| | | | queue. |
| RegionLockRelease | Granted | REGION_LOCK is | Removes the specified region |
| | REGION_LOCK | removed from the | lock from the tree, locates any |
| | structure. | AVL tree. If issued | cleared overlaps and grants |
| | | synchronously, a | the corresponding locks (for |
| | | reply is issued, | each, set Granted = 1 and post |
| | | otherwise there is | the pointer to the response |
| | | no reply‡ | FIFO). If two pending |
| | | | conflicting region locks |
| | | | overlap each other as well as |
| | | | the region lock just released, |
| | | | the one with the earlier |
| | | | sequence number is granted. |
| | | | The comparison is signed, for |
| | | | example (0xFFFC < 0x0002) |
| | | | is TRUE (i.e., 0xFFFC is |
| | | | before 0x0002). |
| RegionLockTypeSet | REGION_LOCK | When granted, RL- | Changes the type of a region |
| | structure in tree, | pointer is posted to | lock (e.g., to promote the type |
| | new Type | the RL response | to exclusive). This may either |
| | | FIFO with | generate new overlaps (in |
| | | Granted = 1. | case of promote) or eliminate |
| | | | overlaps (demote), so the tree |
| | | | is walked to grant or block the |
| | | | region lock request |
| | | | accordingly. A promoted |
| | | | region lock reverts to not |
| | | | granted if there are older |
| | | | overlapping entries in the tree. |
| | | | If granted, the region lock |
| | | | management circuit sets the |
| | | | Granted field to 0x01 and |
| | | | posts a pointer to the granted |
| | | | REGION_LOCK on the |
| | | | response queue. Demoting a |
| | | | region lock may eliminate |
| | | | conflicts between the demoted |
| | | | region lock and other pending |
| | | | overlapping region locks. If |
| | | | conflicts remain between |
| | | | other overlapping region |
| | | | locks, the oldest among the |
| | | | group is granted the region |
| | | | lock. This function is issued |
| | | | as an asynchronous request. |

A request may be entered in the sync request/response interface or in the asynchronous request/response FIFO queues. In one exemplary embodiment, the request/reply entry is simply a pointer to the region lock data structure (REGION_LOCK) that stores the request or response information. The response to a region lock management request is indicated by the state of the Granted field in the REGION_LOCK structure associated with the pointer the region lock management circuit posts to the response FIFO (or sync response interface). Exemplary responses are summarized in the following table:

| | (S)ynchronous/ | Granted | |
|---|---|---|---|
| Applicable Requests | (A)Synchronous | field | Description |
| RegionLockGet, | A | Set to 1 | Indicates a lock was |
| RegionLockTypeSet | | | granted The region lock |
| | | | management circuit |
| | | | posts the address of the |
| | | | REGION_LOCK |
| | | | structure to the response |
| | | | FIFO. |
| | | Set to 0 | Indicates the region lock |
| | | | has not yet been granted. |
| RegionLockRelease | S | N/A | Response generated for |
| | | | synchronous only. |
| RegionLockGetIfAvailable | S | 1 or 0 | Immediate response |
| | | | generated, Grant set to |
| | | | one if available and |
| | | | REGION LOCK |
| | | | remains in tree. Grant set |
| | | | to zero if there are |
| | | | conflicts, and the |
| | | | REGION LOCK |
| | | | structure is not placed in |
| | | | the tree. |
| RegionLockTest | S | Set to 1 | The specified LBA |
| | | | range does not overlap |
| | | | any nodes in the |
| | | | specified region and a |
| | | | RegionLockGet request |
| | | | for the specified range |
| | | | would be granted |
| | | | immediately. |
| | | Set to 0 | The specified LBA |
| | | | range overlaps one or |
| | | | more nodes in the |
| | | | specified region and a |
| | | | lock may not be |
| | | | available until one or |
| | | | more locks with |
| | | | overlapping LBA ranges |
| | | | are released. |

A value of zero in the Region Lock response register indicates the region lock management circuit has not posted a valid response since the last time the Region Lock response FIFO (or sync response interface) was read.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

1. Apparatus in a storage controller of a storage system for managing temporary locking of regions of stored data in the storage system, the storage controller having one or more I/O processor circuits, the apparatus comprising:
a memory adapted to store a plurality of region lock data structures each region lock data structure adapted to identify a region of a logical volume of the storage system that is presently locked or is requested to be locked; and
a region lock management circuit coupled with the memory and adapted to couple with the one or more I/O processor circuits, the region lock management circuit further adapted to access an identified region lock data structure responsive to a region lock management request received from an I/O processor circuit.

2. The apparatus of claim 1
wherein each region lock data structure includes a tree node data structure for linking the region lock data structure in a tree data structure,
wherein the memory is further adapted to store a plurality of region information data structures, each region information data structure associated with a corresponding logical volume of the storage system, each region information data structure including a tree root pointer adapted to point to the tree node data structure of a region lock data structure that is the root of a tree data structure, the tree data structure comprising region lock data structures for regions of the corresponding logical volume that are presently locked or are requested to be locked.

3. The apparatus of claim 2 further comprising:
a tree assist circuit coupled with the memory and coupled with the region lock management circuit, the tree assist circuit adapted to access an identified region lock data structure stored in the memory in a tree data structure identified by a region information data structure.

4. The apparatus of claim 3
wherein the tree data structure is an AVL tree data structure.

5. The apparatus of claim 1
wherein the region lock management circuit is adapted to process a region lock acquire request received from an I/O processor to acquire a lock for an identified region of an identified logical volume of the storage system.

6. The apparatus of claim 5
wherein the region lock management circuit is further adapted to determine, based on the plurality of region lock data structures in the memory, whether the identified region of the region lock acquire request conflicts with any other region of the identified storage volume that is presently locked,
wherein the region lock management circuit is further adapted to return a grant response to the I/O processor in response to a determination that the identified region of the region lock acquire request does not conflict with any other region of the logical volume that is presently locked or is requested to be locked.

7. The apparatus of claim 6
wherein each region lock data structure includes a lock type field indicating a type of the associated locked region wherein the lock type comprises one of an exclusive lock type or one or more non-exclusive lock types,
wherein the region lock management circuit is further adapted to determine whether the identified region of the region lock acquire request conflicts based on the lock type field of the region lock data structure of any other region of a logical volume that is presently locked or is requested to be locked.

8. The apparatus of claim 1
a synchronous request interface comprising a sync request register for receiving a synchronous region lock management request from the I/O processor and comprising a sync response register for storing a response to the synchronous region lock management request.

9. A storage controller comprising:
a front-end interface adapted for coupling the storage controller to a host system;
a back-end interface adapted to couple the storage controller to a plurality of storage devices;
an I/O processor circuit coupled with the back-end interface and coupled with the front-end interface, the I/O processor circuit adapted to receive a host system I/O request through the front-end interface and adapted to process a received I/O request by accessing storage devices through the back-end interface;
a memory coupled with the general-purpose processor and coupled with the I/O processor circuit, the memory adapted to store a plurality of region lock data structures each region lock data structure adapted to identify a region of a logical volume of the storage system that is presently locked or is requested to be locked; and
a region lock management circuit coupled with the memory and coupled with the I/O processor circuit, the region lock management circuit further adapted to access an identified region lock data structure responsive to a region lock management request received from the I/O processor circuit.

10. The storage controller of claim 9
wherein each region lock data structure includes a tree node data structure for linking the region lock data structure in a tree data structure,
wherein the memory is further adapted to store a plurality of region information data structures, each region information data structure associated with a corresponding logical volume of the storage system, each region information data structure including a tree root pointer adapted to point to the tree node data structure of a region lock data structure that is the root of a tree data structure, the tree data structure comprising region lock data structures for regions of the corresponding logical volume that are presently locked or are requested to be locked,
the storage controller further comprising:
a tree assist circuit coupled with the memory and coupled with the region lock management circuit, the tree assist circuit adapted to access an identified region lock data structure stored in the memory in a tree data structure identified by a region information data structure.

11. The storage controller of claim 10
wherein the tree data structure is an AVL tree data structure.

12. The storage controller of claim 9
wherein the region lock management circuit is adapted to process a received region lock acquire request to acquire a lock for an identified region of an identified logical volume of the storage system.

13. The storage controller of claim 12
wherein the region lock management circuit is further adapted to determine, based on the plurality of region lock data structures in the memory, whether the identified region of the region lock acquire request conflicts with any other region of a logical volume of the storage system that is presently locked or is requested to be locked,
wherein the region lock management circuit is further adapted to return a grant response in response to a determination that the identified region of the region lock acquire request does not conflict with any other region of the logical volume that is presently locked or is requested to be locked.

14. The storage controller of claim 13
wherein each region lock data structure includes a lock type field indicating a type of the associated locked region wherein the lock type comprises one of an exclusive lock type or one or more non-exclusive lock types,
wherein the region lock management circuit is further adapted to determine whether the identified region of the region lock acquire request conflicts based on the lock type field of the region lock data structure of any other region of a logical volume that is presently locked or is requested to be locked.

15. A method operable in a storage controller, the storage controller comprising an I/O processor circuit and a region lock management circuit and a memory, the method comprising:
receiving an I/O request from an attached host system;
transmitting a region lock management request from the I/O processor circuit to the region lock management circuit;
receiving in the region lock management circuit a region lock management request from the I/O processor circuit, the request for access to an identified region lock data structure stored in the memory; and
accessing, by operation of the region lock management circuit, the identified region lock data structure.

16. The method of claim 15
wherein each region lock data structure includes a tree node data structure for linking the region lock data structure in a tree data structure,
wherein the memory is further adapted to store a plurality of region information data structures, each region information data structure including a tree root pointer adapted to point to the tree node data structure of a region lock data structure that is the root of a tree data structure, the tree data structure comprising region lock data structures for regions of the corresponding logical volume that are presently locked or are requested to be locked, each region information data structure associated with a corresponding logical volume of the storage system,
wherein the storage controller further comprises a tree assist circuit coupled with the memory and coupled with the region lock management circuit,
wherein the step of accessing further comprises:
exchanging signals between the tree assist circuit and the region lock management circuit to such that the tree assist circuit accesses an identified region lock data structure stored in the memory in a tree data structure identified by a region information data structure provided by the region lock management circuit.

17. The method of claim 16
wherein the tree data structure is an AVL tree data structure.

18. The method of claim 15
wherein the step of receiving the region lock management request further comprises:
receiving a region lock acquire request to acquire a lock for an identified region of an identified logical volume of the storage system.

19. The method of claim 18
wherein the step of accessing further comprises:
determining, based on the plurality of region lock data structures in the memory, whether the identified region of the region lock acquire request conflicts with any other region of the logical volume that is presently locked or is requested to be locked; and
returning a grant response in response to a determination that the identified region of the region lock acquire request does not conflict with any other region of the logical volume that is presently locked or is requested to be locked.

20. The apparatus of claim 1
wherein the region lock management circuit further comprises:
an asynchronous request interface comprising a FIFO memory for receiving queued region lock management requests from the I/O processor and comprising a FIFO memory for storing responses to the queued region lock management requests.
